(19) United States
(12) Patent Application Publication
(10) Pub. No.: US 2008/0037603 A1
(43) Pub. Date: Feb. 14, 2008

(54) Rod-Type Solid Laser Apparatus

(75) Inventors: Junji Kano, Tokyo (JP); Shuichi Fujikawa, Tokyo (JP); Takafumi Kawai, Tokyo (JP)

Correspondence Address: SUGHRUE-265550, 2100 PENNSYLVANIA AVE. NW, WASHINGTON, DC, 20037-3213, US

(73) Assignee: Mitsubishi Electric corporation

(21) Appl. No.: 11/578,604

(22) PCT Filed: Apr. 15, 2004
(86) PCT No.: PCT/JP04/05350

§ 371 Date: Jun. 15, 2007

(51) Int. Cl. H01S 3/17

(52) U.S. Cl. 372/40

(57) ABSTRACT

In a rod-type solid laser apparatus, a laser rod 1 is held by a rod holder 5, the rod holder 5 is held in a recessed portion 40 formed in an adjust ring 7, and the adjust ring 7 is mounted on a cavity container 4. The rod holder 5 is pressed against the cavity container 4 by the bottom surface of the recessed portion 40 of the adjust ring 7, and the diameter of the recessed portion 40 is set slightly larger than the outside diameter of the rod holder 5, whereby the rod holder 5 can be moved freely in the radial direction of the recessed portion 40 within the recessed portion 40. On the adjust ring 7, there are radially disposed two adjust screws 8a, 8b and a spring 9 which respectively extend from the side surfaces of the adjust ring 7 into the recessed portion 40 in such a manner that they are contacted with the rod holder 5. The rod holder is pressed and supported by three points, that is, the respective leading ends of the adjust screws 8a, 8b and spring 9. In the above-structured rod-type solid laser apparatus, when the screwing amounts of the adjust screws 8a, 8b are adjusted, not only the spring 9 can be expanded and compressed but also the position of the rod holder 5 can be adjusted.

### TECHNICAL FIELD

The present invention relates to a rod-type solid laser apparatus which comprises a rod-type solid laser medium, an excitation light source composed of a semiconductor laser for radiating an excitation light on to the solid laser medium from the lateral side of the solid laser medium to excite the solid laser medium, and a rod holder for holding at least one end portion of the solid laser medium, and, specifically, the invention relates to a structure for holding a laser rod and a structure for adjusting the laser rod employed in the above-mentioned rod-type solid laser apparatus.

### BACKGROUND ART

Firstly, terms used in the present invention will be described using an ordinary rod-type solid laser apparatus. Now, FIG. 8 is a structure view of the ordinary rod-type solid laser apparatus. In FIG. 8, three cavities 20a, 20b and 20c, which are respectively box-type devices, are arranged in series and, on the respective cavities 20a, 20b and 20c, there are provided three rod-type solid laser mediums (which are hereinafter referred to as laser rods) 1a, 1b and 1c, each of which is a kind of solid laser medium, and three excitation light sources 22a, 22b and 22c which are respectively composed of semiconductor lasers and are used to excite the laser rods 1a, 1b and 1c. A solid laser apparatus is an apparatus which comprises: the cavities 20a, 20b and 20c; a resonator composed of a total reflecting mirror 24 and a partial reflecting mirror 25 respectively used to take out a laser beam from the solid laser mediums (in FIG. 8, laser rods 1a, 1b and 1c) respectively disposed within their associated cavities 20a, 20b and 20c; and, a fiber incident system 26 for guiding the laser beam to an optical fiber disposed outside an oscillator; and, also which further includes a box body 27 for accommodating therein the cavities 20, total reflecting mirror 24, partial reflecting mirror 25 and fiber incident system 26 and also for supporting the positions of these elements directly or through various members. As shown in FIG. 8, when the solid laser medium is composed of a laser rod, the solid laser apparatus is referred to as the rod-type laser apparatus. The rod-type laser apparatus is characterized in that, by arranging the cavities in series so as to adjoin each other, the laser power thereof can be increased. For example, although, in FIG. 8, the three cavities 20a, 20b and 20c are arranged in series, the number of cavities may be increased or decreased according to a desired laser power.

Also, in the present invention, a direction, which is decided by the normal of the resonator mirror reflecting surface, is referred to as a resonator optical axis; and, the optical axis of a laser beam in an actually resonating state within the resonator is referred to as a laser optical axis. The laser optical axis intersects at right angles with the reflecting surface of the resonator mirror and is thus parallel to the resonator optical axis. Also, the geometric center axis of the laser rod is referred to as a rod center axis. When the laser rods are excited symmetrically with respect to the rod center axis by the excitation light source, it is important to allow the rod center axis to coincide with the resonator optical axis.

Next, description will be given below of problems found in the ordinary rod-type solid laser apparatus. In the rod-type solid laser apparatus, in order to prevent the laser rod from being thermally destroyed due to heat generation, normally, the side surfaces of the laser rod are cooled using cooling water the like. When an excitation light is radiated onto the laser rod, heat generated in the inside of the laser rod and the cooling of the side surfaces of the laser rod cause a temperature distribution, which provides a similar optical operation to a lens (which is referred to as a heat lens phenomenon). Because of this, a laser beam under resonation is, as shown in FIG. 9(a), in a refraction state where the beam diameter of a laser beam 30 is large in the central portion of a laser rod 1 and the beam diameter of the laser beam 30 is small in the end portions of the laser rod 1. Here, FIG. 9 shows an example in which the number of cavities is one. Laser power, which can be taken out from one laser rod, varies according to the volume 31 of a laser rod (which, in FIG. 9, is shown by a shaded portion and is referred to as a mode volume) that the laser beam in a resonating state can transmit through. Assuming that the laser rod 1 is excited symmetrically with respect to the rod center axis 32, as shown in FIG. 9(a), when the rod center axis 32 of the laser rod 1 coincides with a resonator optical axis 33, the mode volume 31 becomes the greatest. Actually, however, owing to the slight position deviation of the laser rod 1, as shown in FIG. 9(b), the rod center axis 32 of the laser rod 1 and resonator optical axis 33 are deviated from each other, the mode volume 31 is decreased accordingly, and the laser power that can be taken out is lowered. This means the lowered oscillation efficiency of the cavity and raises one of the important problems when the solid laser apparatus is put into actual application.

Further, when cavities are arranged adjoining each other in the rod-type solid laser apparatus, assuming that the laser rod 1 is excited symmetrically with respect to the rod center axis 32, the laser beam, as shown in FIG. 10(a), passes through the laser rods 1a and 1b of the respective cavities. However, as shown in FIG. 10(b), when the rod center axes 32a and 32b of the laser rods 1a and 1b of the mutually adjoining cavities are deviated from each other, a diffraction loss increases, while mode volumes 31a and 31b decrease. Here, FIG. 10 shows an example where two cavities are used. As a result of this, the laser power that can be taken out is lowered. This means that the connecting efficiency of the cavities is lowered. The larger the number of adjoining cavities is, the more the diffraction loss is, so that the connecting efficiency of the cavities is easy to lower. Since to increase the output of the laser power is an important demand item in the laser industry, it is also one of the important problems in the practical application of the solid laser apparatus to enhance the cavity connecting efficiency.

The conventional rod-type solid laser apparatus has been trying to enhance the position precision of the laser rod within the cavity not only to make the rod center axis of the laser rod approach the resonator optical axis but also to make the rod center axes of the mutually adjoining cavities coincide with each other. However, owing to the dimensional tolerances of the laser rods, variations in the assembling operations of the laser rods and the like, there exists a limit value in the enhancement of the position precision of the laser rods.

Also, because of variations in the position precision of the laser rods and excitation light source, the excitation distribution within the laser rod can be hardly symmetrical with respect to the rod center axis. In this case, the axis of the laser rod the laser beam output of which is the greatest exists in a direction different from the rod center axis. The axis of the laser rod the laser beam output of which is the greatest is herein referred to as a rod maximum output axis, whereas the geometric center axis of the laser rod is referred to as the rod center axis. Although such description was given before that, when the laser rod is excited symmetrically with respect to the rod center axis by the excitation light source, it is important to make the rod center axis coincide with the resonator optical axis, essentially, it means that the rod maximum output axis is made to coincide with the resonator optical axis.

For the above-mentioned reasons, means for enhancing the position precision of the laser rod in the conventional rod-type solid laser apparatus is not sufficient to function as means for enhancing the oscillation efficiency and connecting efficiency of the cavities.

As an example of the prior art, in a conventional rod-type solid laser apparatus disclosed in the Japanese patent publication Hei-10-190096, there is employed a position adjust mechanism for adjusting the position of a laser rod from the multiple sides of the laser rod using adjust screws. This mechanism is capable of making the rod center axis of the laser rod approach the resonator optical axis. However, in this mechanism employing the adjust screws applied from the multiple sides, the laser rod is operated only by the load of the adjust screw in the feeding direction thereof, while the adjust screw on the opposite side must be always loosened. Therefore, to adjust the rod center axis position with high precision, it takes great time and labor as well as requires a technical skill at the operator's end. Also, as described before, even when the rod center axis of the laser rod perfectly coincides with the resonator optical axis, the resonator optical axis does not always coincide with the rod maximum output axis of the laser rod where the laser output is the greatest. For these reasons, this technique is also insufficient as means for enhancing the oscillation efficiency and connecting efficiency of the cavities.

Also, generally, in the rod-type solid laser apparatus, whether the cavities are connected or not, after the cavities and resonator are arranged, the angle of the mirror of the resonator is adjusted such that the laser power can be the greatest. The reason for this is that, as described above, the rod maximum output axis, where the output of the laser rod is the greatest, varies according to the cavities. Thus, in the conventional rod-type solid laser apparatus, when there is raised the need for replacement of a cavity due to the maintenance, inspection and trouble thereof, each time the cavity is replaced, it is necessary to adjust the angle of the mirror of the resonator. Further, as the angle of the mirror is varied due to the adjustment of the resonator, the laser optical axis of the laser beam is also varied; and, therefore, it is necessary to adjust again an optical path for fiber transmission and thus it takes time to maintain the rod-type solid laser apparatus.

### DISCLOSURE OF THE INVENTION

The present invention aims at eliminating the above problems found in the conventional rod-type solid laser apparatus. Thus, it is an object of the invention to provide a rod-type solid laser apparatus which includes a mechanism for easily adjusting a laser rod to an arbitrary position and allows a rod maximum output axis to approach a resonator optical axis to thereby be able to enhance the oscillation efficiency and connecting efficiency of cavities. Also, it is another object of the invention to provide a rod-type solid laser apparatus which makes use of the adjust mechanism to thereby eliminate or simplify the maintenance of the cavities when one or more of the cavities is or are replaced.

In a rod-type solid laser apparatus according to the invention, there is provided an adjust ring for holding in a recessed portion thereof a rod holder for holding a laser rod in the end portion of a cavity, there is provided within the adjust ring at least one elastic member capable of pressing the rod holder from the lateral side thereof, and there is provided adjust means for adjusting a distance between the rod holder and adjust ring.

According to the invention, since there is provided the adjust means for adjusting a distance between the rod holder for holding the laser rod in the cavity end portion and the adjust ring for holding the rod holder in the recessed portion thereof, the laser rod in the rod-type solid laser apparatus can be adjusted to an arbitrary position.

### BRIEF DESCRIPTION OF THE DRAWINGS

FIG. 1(a) is a transverse section view of a rod-type solid laser apparatus according to an embodiment 1 of the invention.

FIG. 1(b) is a longitudinal section view of a rod-type solid laser apparatus according to the embodiment 1 of the invention.

FIG. 2(a) is a transverse section view of a rod-type solid laser apparatus according to an embodiment 2 of the invention.

FIG. 2(b) is a longitudinal section view of a rod-type solid laser apparatus according to the embodiment 2 of the invention.

FIG. 2(c) is a transverse section view of another rod-type solid laser apparatus according to the embodiment 2 of the invention.

FIG. 3(a) is a transverse section view of a rod-type solid laser apparatus according to an embodiment 3 of the invention.

FIG. 3(b) is a longitudinal section view of a rod-type solid laser apparatus according to the embodiment 3 of the invention.

FIG. 4 is a longitudinal section view of a rod-type solid laser apparatus according to an embodiment 4 of the invention.

FIG. 5(a) is a transverse section view of a rod-type solid laser apparatus according to an embodiment 5 of the invention.

FIG. 5(b) is a longitudinal section view of a rod-type solid laser apparatus according to the embodiment 5 of the invention.

FIG. 6 is a longitudinal section view of a rod-type solid laser apparatus according to an embodiment 6 of the invention.

FIG. 7 is a longitudinal section view of a rod-type solid laser apparatus according to an embodiment 7 of the invention.

FIG. 8 is a structure view of a rod-type solid laser apparatus.

FIG. 9 is a conceptual view of a laser rod, a resonator mirror, and a laser under resonation.

FIG. 10 is a conceptual view of a laser rod, a resonator mirror, and a laser under resonation.

### BEST MODE FOR CARRYING OUT THE INVENTION

### Embodiment 1

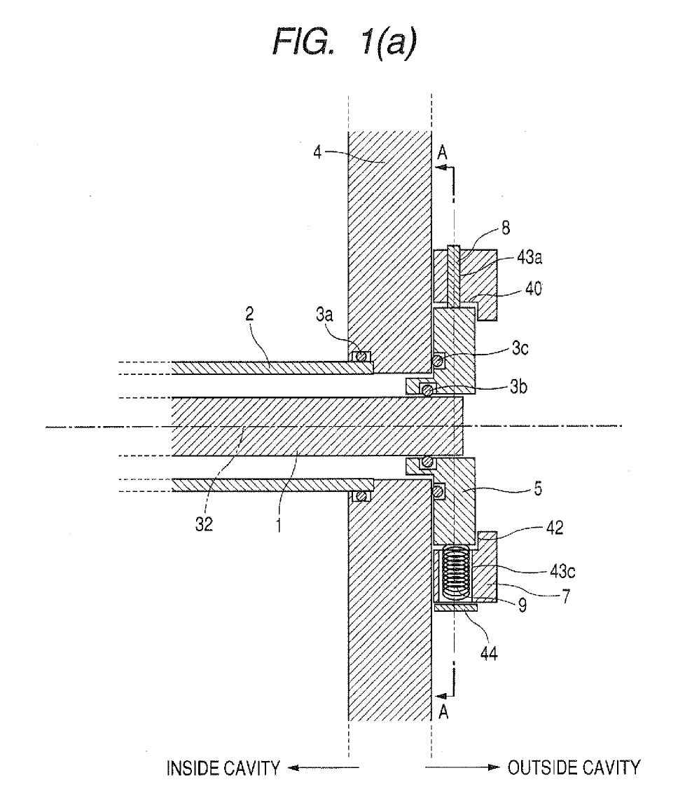

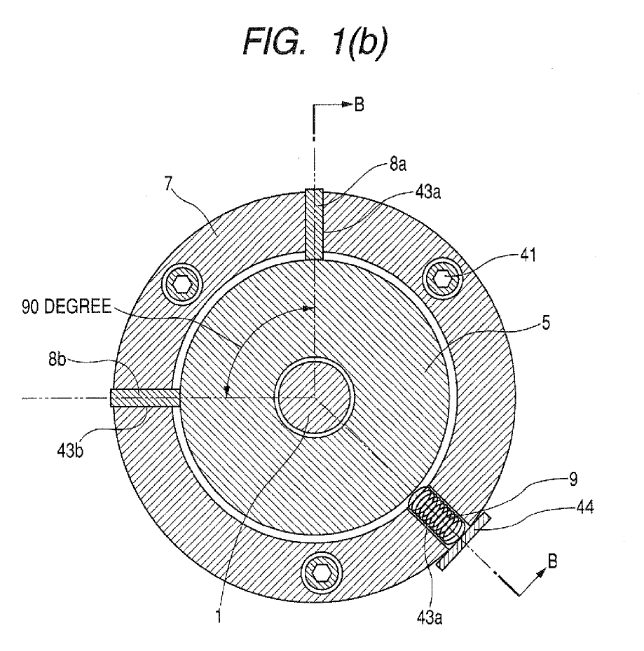

Now, FIG. 1 shows a rod-type solid laser apparatus according to an embodiment 1 of the invention and, specifically, it is a section view of one laser rod hold portion formed in one end portion of a cavity which is shown by a dotted round mark A in FIG. 8. The other hold portion is the same in structure as the hold portion shown in FIG. 1 and is arranged symmetrical to FIG. 1. More specifically, FIG. 1(a) is a transverse section view of the rod-type solid laser apparatus and FIG. 1(b) is a longitudinal section view thereof; and, FIG. 1(a) is a section view taken along the line B-B shown in FIG. 1(b), while FIG. 1(b) is a section view taken along the line A-A shown in FIG. 1(a).

In FIG. 1, a laser rod 1 is held by a rod holder 5 through an O ring 3b, the rod holder 5 is held in a recessed portion 40 formed in an adjust ring 7, and the adjust ring 7 is mounted by fixing screws 41 on a cavity container 4 having an opening in the vicinity of the axis of the laser rod 1. Here, the adjust ring 7 is mounted on the box-shaped cavity container 4 but a member, on which the adjust ring 7 is to be mounted, is not limited to the box-shaped cavity container 4. For example, there may also be employed a support plate composed of a pair of plate members which are respectively supported on the box body 27, are respectively disposed on the two end portions of the laser rod 1, and each of which has an opening in the vicinity of the axis of the laser rod 1. The rod holder 5 is pressed against the cavity container 4 through an O ring 3c by the bottom surface of the recessed portion 40 of the adjust ring 7, and the diameter of the recessed portion 40 is set slightly larger than the outside diameter of the rod holder 5, whereby the rod holder 5 can be moved freely in the radial direction of the recessed portion 40 (on a plane in FIG. 1(b)) within the recessed portion 40. In the adjust ring 7, there are formed three penetration holes, that is, a first penetration hole 43a, a second penetration hole 43b and a third penetration hole 43c which respectively extend radially from the side surface of the adjust ring 7 to the recessed portion 40. As shown in FIG. 1(b), an angle formed between the first penetration hole 43a and second penetration hole 43b is set about 90 degrees, while the third penetration hole 43c is formed at a position symmetrical to the intermediate position between the first and second penetration holes 43a and 43b with respect to the center of the recessed portion 40. In the respective inner surfaces of the first and second penetration holes 43a and 43b, there are formed female screws respectively, while two adjust screws 8a and 8b with male screws formed on the outer surfaces thereof are screwed into the first and second holes 43a and 43b respectively. The leading ends of the thus screwed adjust screws 8a and 8b are in contact with the rod holder 5. According to the screwed amounts of the adjust screws 8a and 8b, the projecting amounts of the leading end portions of the adjust screws 8a and 8b into the recessed portion 40 of the adjust ring 7 can be adjusted. A spring 9 is inserted into the third penetration hole 43c, while the leading end of the spring 9 is contacted with the rod holder 5 and is pressed against the rod holder 5. On the adjust ring 7 side surface opening of the third penetration hole 43c, there is mounted a cover 44 which prevents the spring 9 from projecting out of the third penetration hole 43c. Here, the adjust ring 7 side surface opening of the third adjust hole 43c is covered with the cover 44; however, this is not limitative but, for example, the third penetration hole 43c may also be formed as a no-penetration hole which does not penetrate to the side surface of the adjust ring 7. In this case, even without using a cover, the spring 9 can be prevented from projecting to the side surface of the adjust ring 7. The spring 9 acts such that it presses the rod holder 5 against the fixing screws 8a and 8b; and, the rod holder 5 is pushed by three points, that is, the respective leading end portions of the adjust screws 8a, 8b and spring 9, while the rod holder 5 is supported at a position within a plane shown in FIG. 1(b).

Also, as shown in FIG. 1(a), in order to cool the side surface of the laser rod 1, a cylindrical-shaped flow tube 2 is fixed to the cavity container 4 through an O ring 3a so as to surround the periphery of the laser rod 1, whereby there is formed in the periphery of the laser rod 1a water passage through which cooling water is allowed to flow. The cooling water flows through a space sealed by the laser rod 1, flow tube 2, cavity container 4, rod holder 5 and O rings 3a, 3b, 3c respectively inserted between these respective parts, thereby cooling the laser rod 1.

In the laser rod hold portion of the cavity container of the rod-type solid laser apparatus structured in this manner, by adjusting the screwing amounts of the adjust screws 8a and 8b, not only the spring 9 can be expanded and compressed but also the position of the rod holder 5 in the plane shown in FIG. 1(b) can be adjusted. Also, because the laser rod 1 is held by the rod holder 5, by adjusting the position of the rod holder 5, the position of the laser rod 1 can also be adjusted synchronously with the position adjustment of the rod holder 5.

Loads applied to the rod holder 5 from the adjust screws 8a, 8b and from spring 9 are always reaction forces with respect to each other and thus, regardless of the feeding direction of the adjust screws 8a and 8b, by operating only the adjust screws 8a and 8b, the position of the laser rod 1 can be adjusted. For example, there is eliminated the need to previously loosen the adjust screw 8b when adjusting the adjust screw 8a as in the conventional rod-type solid laser apparatus.

Also, since the two adjust screws 8a and 8b are arranged almost at right angles to each other, when the adjusting amount is not so large, by operating or feeding the adjust screw 8a, not only the spring 9 can be expanded and compressed but also the position of the laser rod 1 can be adjusted almost in the vertical direction in FIG. 1(b). And, by operating the adjust screw 8b, not only the spring 9 can be expanded and compressed but also the position of the laser rod 1 can be adjusted almost in the right and left direction in FIG. 1(b). Thus, the adjustments of the laser rod 1 by the adjust screws 8a and 8b can be made almost independently of each other, which makes it easy to adjust the position of the laser rod 1.

Further, according to the present embodiment, as shown in FIG. 1(a), the O ring 3c always seals between the rod holder 5 and cavity 4 even while the position of the rod holder 5 is being adjusted, which makes it possible to adjust the position of the laser rod 1 while running the cooling water.

The above-mentioned structures can realize a rod alignment in which the laser is actually oscillated, the power of the laser beam outputted is measured, and the hold position of the laser rod 1 is adjusted so as to make the power greatest. This rod alignment is not an adjusting method for allowing the geometrically determined rod center axis of the laser rod 1 to coincide with the resonator optical axis, but an adjusting method which adjusts the position of the laser rod 1 while a deviation between the rod center axis and the rod maximum output axis caused by variations in the excitation distribution of the laser rod 1 is taken into consideration. That is, this is an adjusting method which can determine such position of the laser rod as can make the laser output greatest with respect to the resonator axis; and, in other word, this is the best laser rod position adjusting method which can make the resonator optical axis and the rod maximum output axis coincide with each other.

In a process for enforcing the rod alignment, when not only the arranging positions of the rod-type solid laser apparatus, resonator, and instruments used for the rod alignment such as a laser power measuring instrument but also the using environments such as temperatures, humidity, voltages to be used, and currents to be fed are set the same, there can be produced two or more cavities in which the rod maximum output axis is coincident with almost the same resonator optical axis. When the cavities are arranged adjoining each other as oscillation stages or amplifying stages in order to obtain a high output, by using the cavities each having the rod maximum output axis on almost the same resonator optical axis, a diffraction loss between the cavities can be minimized and the reduction of the mode volume can be restricted. This makes it possible to increase the total output of the present apparatus over the conventional rod-type solid laser apparatus. That is, the connecting efficiency of the cavities can be enhanced.

Further, since two or more cavities each having the rod maximum output shaft on almost the same resonator optical axis can be produced, the time necessary for replacement of the adjacently arranged cavities can be shortened greatly. Generally, when one cavity is replaced due to trouble or for maintenance, such replacement involves various adjustments such as the adjustment of the resonator mirror, the adjustment of the laser optical path, and an adjustment for guiding the laser beam to the fiber. When a cavity having the rod maximum output axis on almost the same resonator optical axis is replaced, it is not necessary to make these adjustments.

By the way, in the present embodiment, the angle formed between the two adjust screws 8a and 8b is set 90 degrees. However, according to the invention, the angle formed between the two adjust screws 8a and 8b is not limited to 90 degrees, but, for example, the first, second and third holes may be arranged symmetrically and radially at angular intervals of 120 degrees. However, since the directions of adjustments by the respective adjust screws are not perpendicular to each other, the adjustments cannot be made independently but converging adjustments are necessary. Therefore, it is desirable that the angle between the adjust screws may be set 90 degrees. It goes without saying that the angle between the adjust screws must be less than 180 degrees. Also, the number of adjust screws and springs is not limited to the present embodiment but, for example, three adjust screws may be screwed from three directions or two springs are used to push the rod holder 5. However, it goes without saying that the present embodiment is the simplest and most effective structure.

Also, in the present embodiment, description has been given while using the adjust screws 8a, 8b and spring 9 for positioning of the rod holder 5. However, the positioning of the rod holder 5 according to the invention is not limited to the screws and springs, but, of course, it can also be set by using ordinary pushing parts and elastic members. Also, the shape of the adjust ring is not limited to the ring shape but, of course, rings having other shapes than the ring shape can also be used.

### Embodiment 2

In the embodiment 1, the position of the laser rod 1 is decided by holding the rod holder 5 in such a manner that the rod holder 5 is pushed from the three points, that is, the two adjust screws 8a, 8b and the spring 9. However, in the case of the holding method using the pressures of the elastic members, there is a possibility that the position of the rod holder 5, that is, the position of the laser rod 1 can be varied due to the wrong operations of the adjust screws 8 and external disturbances such as collisions and vibrations. According to the present embodiment, there is provided means for fixing the position of the rod holder 5 after the position of the laser rod 1 is adjusted. Now, the parts of the present embodiment which are the same as to those employed in the embodiment 1 are given the same reference numerals and the description thereof is omitted here. Thus, description will be given below only of the parts of the present embodiment which are different from those of the embodiment 1.

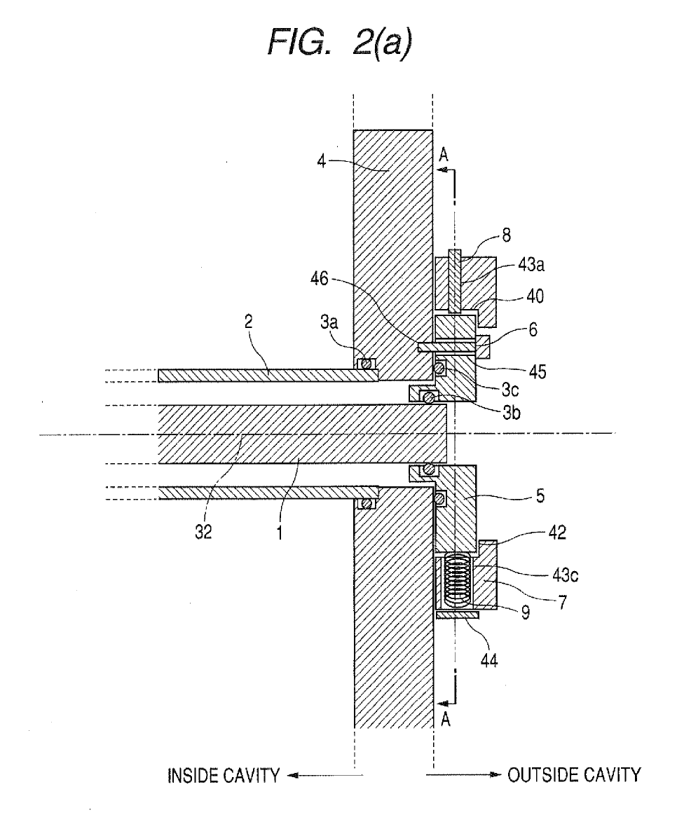

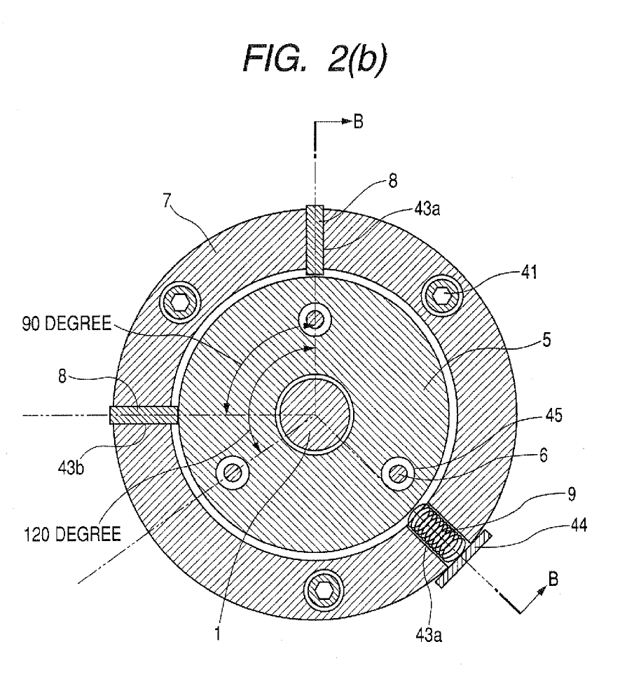

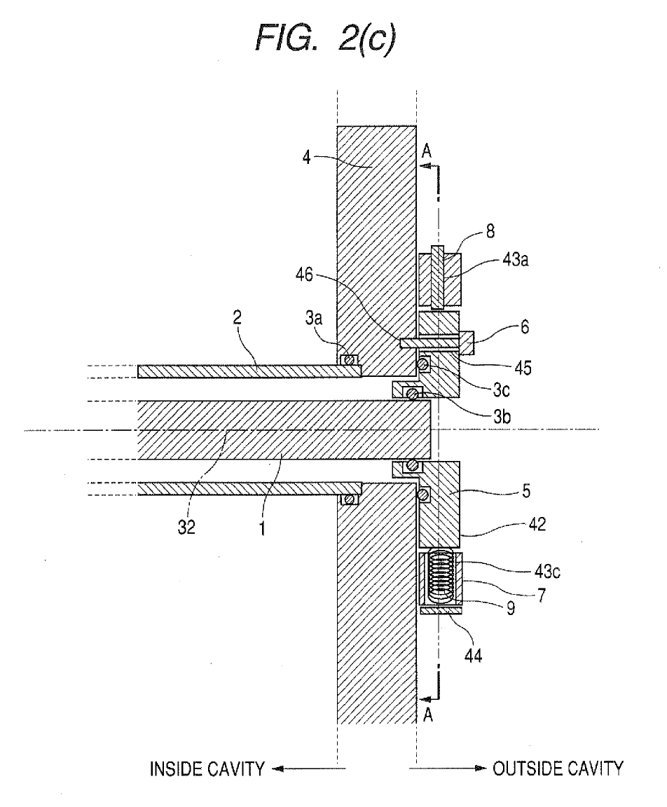

Here, FIG. 2 shows a rod-type solid laser apparatus according to the embodiment 2 of the invention and, specifically, FIG. 2 is a section view of a laser rod hold portion formed in one end portion of a cavity container. The other hold portion is also the same in structure as that shown in FIG. 2 and is arranged symmetric to that shown in FIG. 2. FIGS. 2(a) and 2(b) are respectively section views in the same direction as the embodiment 1.

In FIG. 2, in the rod holder 5, there is opened up a penetration hole 45 which penetrates from the outer surface of the rod holder 5 to the surface thereof in contact with the cavity container 4 and through which a fixing screw 6 can be inserted. Also, the cavity container 4 also has a no-penetration hole 46 which is formed in the surface thereof in contact with the rod holder 5 and is coaxial with the penetration hole 45. As shown in FIG. 2(b), the penetration hole 45 and no-penetration hole 46 are arranged respectively in three rotational symmetry points or positions at angular intervals of 120 degrees. However, the numbers and positions of the penetration holes 45 and no-penetration holes 46 are not limited to this but can be decided properly depending on the size of the rod holder and the like. On the inner surface of the no-penetration hole 46, there is formed a female screw, and thus the fixing screw 6 having a male screw formed on the external surface thereof can be screwed into the no-penetration hole 46. Also, the diameter of the penetration hole 45 is set larger than the diameter of the fixing screw 6. Even in a state where the fixing screw 6 is inserted into the penetration hole 45, the rod holder 5 can be moved in the radial direction (on a plane shown in FIG. 2(b)) of the recessed portion 40 of the adjust ring 7, whereby the position of the rod holder 5 can be adjusted using the adjust screws 8a and 8b. Further, since the diameter of the head portion of the fixing screw 6 is set larger than the diameter of the penetration hole 45, as the fixing screw 6 is screwed into the no-penetration hole 46, the head portion of the fixing screw 6 is pressed against the external surface of the rod holder 5 to thereby be able to fix the rod holder strongly 5 to the cavity container 4.

Due to employment of the above-mentioned structure, according to the present embodiment 2, when the fixing screw 6 is tightened after the rod hold position is adjusted, the position of the laser rod 1 with the rod maximum output axis adjusted to the resonator optical axis can be maintained fast, thereby being able to provide a resisting force against the wrong operations of the adjust screw 8 and external disturbances such as collisions and vibrations. To adjust the position of the laser rod 1 again, the fixing screw 6 may be loosened, the adjust screws 8 may be adjusted and, after end of adjustment of the adjust screws, the fixing screw 6 may be tightened again. This rod holder fixing means may also be used in other embodiments which will be discussed later. In that case as well, it is obvious that there can be obtained similar effects to the present embodiment.

By the way, in the embodiments 1 and 2, there is employed a structure in which the rod holder 5 is pressed against the cavity container 4 by the bottom surface of the recessed portion 40 formed in the adjust ring 7. However, the rod holder 5 may also be pressed against the cavity container 4 by the fixing screw 6 which, in the embodiment 2, functions as means for fixing the rod holder 5. In this case, as shown in FIG. 2(c), there is not formed a recessed portion in the adjust ring 7, but the adjust ring 7 may be used simply as holding means for holding not only the positions of the adjust screws 8 functioning as adjusting means for adjusting the position of the rod holder 5 but also the position of the spring 9 which is an elastic member for pushing the rod holder 5. This provides an advantage that the structure of the adjust ring 7 can be simplified.

### Embodiment 3

In the embodiment 1, the adjust screws 8 are respectively screwed into their associated penetration holes 43 which extend from the side surface of the adjust ring 7 to the recessed portion 40. On the other hand, according to the present embodiment, there is formed a penetration hole which extends from the bottom surface of the cavity container 4 to the recessed portion 40, an adjust screw is screwed into this penetration hole, and, to the portion of the rod holder 5 with which the adjust screw can be contacted, there is added a butting surface for the adjust screw 8. The parts of the present embodiment which are the same in structure to those of the embodiment 1 are given the same reference numerals and the description thereof is omitted here. Thus, description will be given below only of the parts of the present embodiment which are different from those of the embodiment 1.

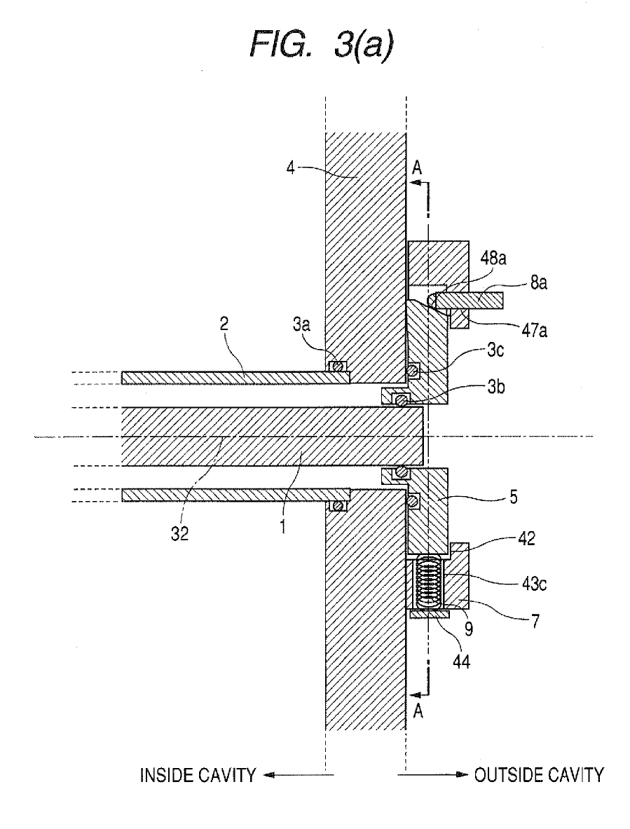

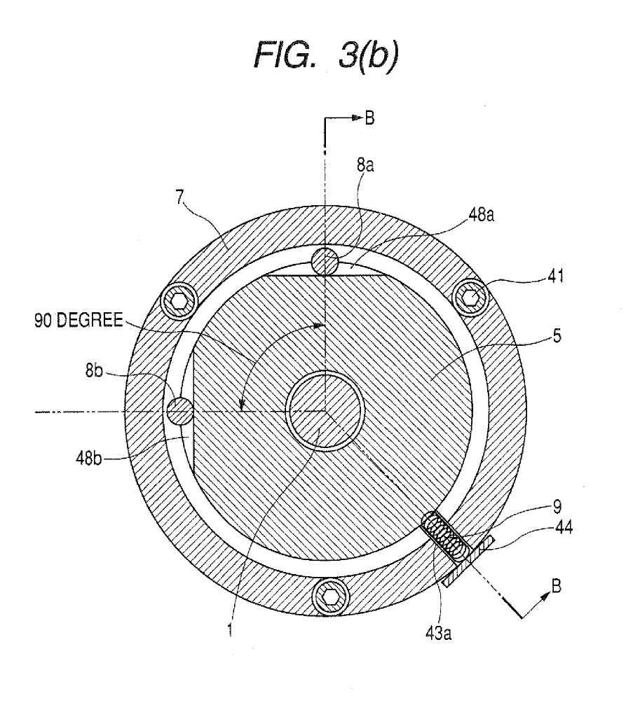

Now, FIG. 3 shows a rod-type solid laser apparatus according to the present embodiment of the invention and, specifically, it is a section view of one laser rod hold portion formed in one end portion of a cavity container. The other hold portion is also the same in structure as that shown in FIG. 3 and is arranged symmetric to that shown in FIG. 3. More specifically, FIGS. 3(a) and 3(b) are respectively section views taken in the same direction as the embodiment 1.

In FIG. 3, there are eliminated the first and second holes 43a and 43b which are shown in FIG. 1, instead of them, there are formed a first penetration hole 47a and a second penetration hole 47b which respectively extend from the bottom surface of the adjust ring 7, that is, the surface of the adjust ring 7 existing on the opposite side of the surface of the adjust ring 7 that is in contact with the cavity container 4, to the recessed portion 40 and also which extend perpendicularly to the bottom surface of the adjust ring 7. As shown in FIG. 3(b), the respective penetration holes are arranged almost on the same circumference in such a manner that an angle formed between them is set almost 90 degrees. The positions of the present penetration holes substantially correspond to the positions of the first and second holes 43a and 43b shown in FIG. 1. The first and second penetration holes 47a and 47b respectively include female screws formed on the inner surfaces thereof, while the adjust screws 8a and 8b are screwed into the first and second penetration holes 47a and 47b respectively. The leading ends of the thus screwed adjust screw 8a and 8b are respectively in contact with the rod holder 5. In the portions of the rod holder 5 with which the adjust screws 8a and 8b are contacted, there are formed butting surfaces 48a and 48b respectively. The butting surfaces 48 are respectively inclined surfaces which are neither parallel nor perpendicular to the axial direction of the adjust screws 8, and the directions of the butting surfaces 48 are set such that the normal lines thereof are almost situated within a plane which contains the laser rod axis 32.

Due to employment of the above structure, according to the present embodiment 3, because the angle formed between the two adjust screws 8a and 8b is set almost 90 degrees, and also because the direction of the butting surface 48 is arranged such that the normal line thereof substantially coincides with the radial direction of the recessed portion 40, for example, when the screwing amount of the adjust screw 8a is adjusted, because the butting surface 48a composed of an inclined surface is formed in such portion of the rod holder 5 that the adjust screw 8a is contacted with, there is applied a pressing force to the rod holder 5 in a direction perpendicular to the screwing direction of the adjust screw 8a, whereby the spring 9 is expanded and compressed and thus the position of the rod holder 5 can be adjusted almost in the vertical direction in FIG. 3(b). On the other hand, when the screwing amount of the adjust screw 8b is adjusted, owing to a similar action to the above action, the position of the rod holder 5 can be adjusted almost in the right and left direction in FIG. 3(b).

Thus, similarly to the embodiment 1, according to the present embodiment as well, by adjusting the adjust screws 8, the position of the rod holder 5, that is, the position of the laser rod 1 can be adjusted simply and easily. Of course, the rod alignment is also possible. Also, according to the present embodiment, not only there can be obtained a similar effect to the embodiment 1, but also there can be provided an advantage that there is eliminated the need for provision of a maintenance space for the adjust screws 8 in the outer periphery of the adjust ring 7.

By the way, according to the present embodiment, although the angle between the adjust screws 8 is set almost 90 degrees and the direction of the butting surface 48 is set such that the normal line thereof is almost situated within a plane containing the laser rod axis 32, the present invention is not specifically limited to this setting. However, owing to such setting, the adjusting directions of the position of the laser rod 1 by the adjust screws 8a and 8b are almost perpendicular to each other; and, therefore, there can be provided an advantage that the adjustment of the position of the laser rod 1 can be facilitated. The number of adjust screws 8 and springs 9, as described above in connection with the embodiment 1, is not limited to any special number. Also, although the butting surface 48 is formed simply as an inclined surface, it may also be formed as a tapered surface. Further, although the penetration hole 47 is formed perpendicularly to the bottom surface of the adjust ring 7, it may also be inclined. In addition, such arrangement of the adjust screws may also be used in other embodiments and, in that case as well, of course, there can be obtained similar effects to the present embodiment.

### Embodiment 4

In the embodiment 1, the leading ends of the adjust screw 8 and spring 9 are respectively in direct contact with the rod holder 5. On the other hand, according to the present embodiment, on the side surface of the rod holder 5, there is disposed a bush 10. Here, the parts of the present embodiment which are the same in structure as those of the embodiment 1 are given the same reference numerals and the description thereof is omitted. Thus, description will be given below only of the parts of the present embodiment which are different form the embodiment 1.

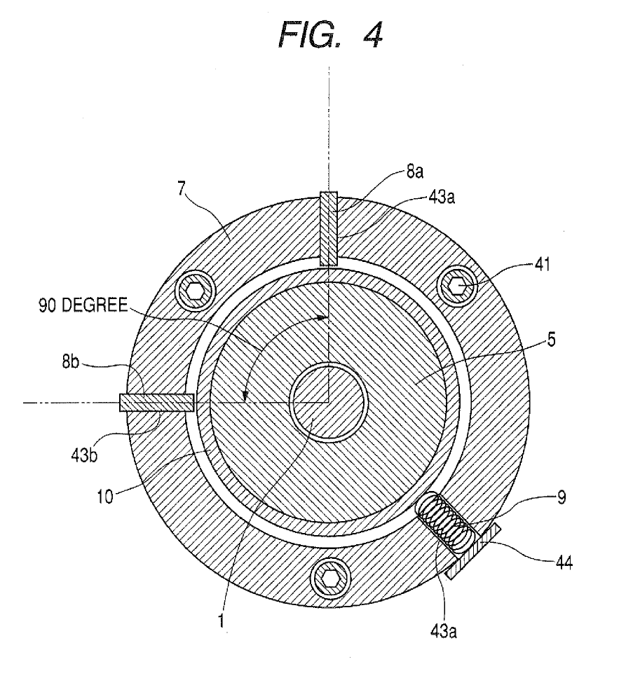

Now, FIG. 4 shows a rod-type solid laser apparatus according to an embodiment 4 of the invention and, specifically, it is a section view of one laser rod hold portion formed in one end portion of a cavity container. The other laser rod hold portion is the same in structure as that shown in FIG. 4 and is arranged symmetrical to that shown in FIG. 4. Also, FIG. 4 is a transverse section view taken in the same direction as FIG. 1(b) which relates to the embodiment 1.

In FIG. 4, on the side surface of the rod holder 5, there is disposed a bush 10, while the rod holder 5 and bush 10 are fixedly secured to each other. The adjust screws 8 and spring 9 are pressed against the bush 10 to thereby hold the position of the laser rod 1. Also, by carrying out a similar operation to the embodiment 1, the position of the laser rod 1 can be adjusted.

According to the present embodiment, not only by providing the bush 10 on the side surface of the rod holder 5, there can be obtained a similar effect to the embodiment 1, but also a frictional resistance generated between the rod holder 5 and adjust screws 8 in the embodiment 1 can be reduced by interposing the bush 10 between them to thereby be able to smooth the operation of the rod holder 5, which can in turn facilitate the position adjustment of the laser rod 1. The bush 10 may be selectively made of metal or nonmetal which can reduce the above-mentioned frictional resistance. Of course, such adjust screw arrangement may also be used in other embodiments and, in that case as well, it goes without saying that a similar effect to the present embodiment can be obtained.

### Embodiment 5

In the embodiment 4, by providing the bush 10 on the side surface of the rod holder 5, the frictional resistance generated between the rod holder 5 and adjust screws 8 can be reduced to thereby be able to smooth the operation of the rod holder 5. According to the present embodiment 5, by making use of the thus reduced frictional resistance between the rod holder 5 and adjust screws 8, there is provided a mechanism for rotating the laser rod 1. In the following description, the parts of the present embodiment which are the same in structure as those of the embodiments 1 and 4 are given the same reference numerals and thus the description thereof is omitted here. That is, description will be given below only of the parts of the present embodiment which are different from those of the embodiments 1 and 4.

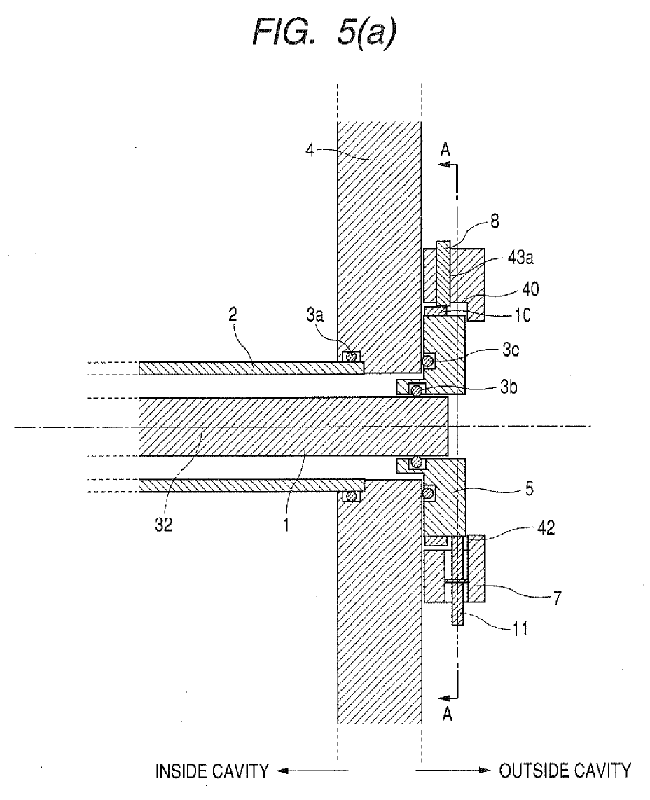

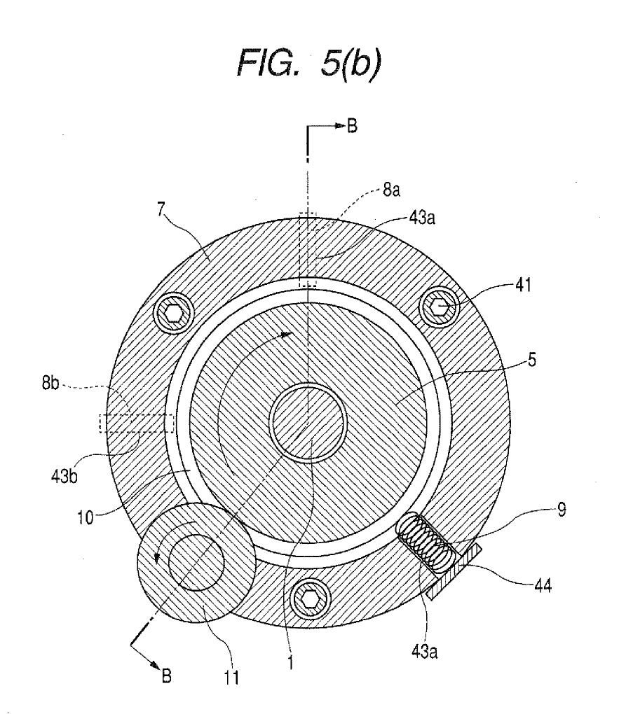

Now, FIG. 5 shows a rod-type solid laser apparatus according to an embodiment 5 of the invention and, specifically, it is a section view of one laser rod hold portion formed in one end portion of a cavity container. The other laser rod hold portion is the same in structure as the laser rod hold portion shown in FIG. 5 and is arranged symmetrical to the laser rod hold portion shown in FIG. 5. More specifically, FIGS. 5(a) and 5(b) are respectively section views taken along the same direction as the embodiment 1.

In FIG. 5, the bush 10 provided on the side surface of the rod holder 5 is arranged in the portion of the side surface of the rod holder 5 that is in contact with the adjust screw 8 on the cavity container 4 side, whereas the side surface of the bush 10 near to the outside surface of the side surface of the rod holder S is exposed as it is. On the adjust ring 7, there is rotatably mounted a disk-shaped adjust roller 11 having an axis substantially parallel to the axis of the laser rod 1. The side surface of the adjust roller 11 is in contact with the side surface of the rod holder 5 on the outer surface side thereof where the bush 10 is not provided, and the respective side surfaces are surface worked so that they are prevented from sliding with respect to each other; and, when the adjust roller 11 is rotated, the rod holder 5 can be rotated and, synchronously with the rotation of the rod holder 5, the laser rod 1 can also be rotated. Also, the adjust roller 11 mounted on the adjust ring 7 is mounted in such a manner that it can be moved in the radial direction of the recessed portion within a plane in FIG. 5(b) and is also pressed against the rod holder 5 by an elastic member (not shown) or the like. Therefore, when adjusting the position of the rod holder 5, the adjust roller 11, while it is varying in position synchronously with the position of the rod holder 5, is always able to keep its contact with the rod holder 5.

According to the present embodiment, not only because the bush 10 is provided on the side surface of the rod holder 5 but also because the adjust roller 11 is mounted on the adjust ring 7, there can be obtained a similar effect to the embodiment 4 and also the direction of the circumferential direction of the laser rod 1 can be set arbitrarily.

By the way, since the adjust roller 11 applies pressure to the rod holder 5, when the adjust roller 11 is provided in the position of the spring 9 instead of the spring 9, it is possible to realize a similar action to the spring 9, which can provide an advantage that the spring 9 can be saved when compared with the above-mentioned embodiment 1.

### Embodiment 6

In the embodiment 1, the two adjust screws 8a, 8b and spring 9 are arranged in such a manner as shown in FIG. 1(b), the rod holder 5 is supported at the three points, and the angle formed between the two adjust screws 8a and 8b is set almost 90 degrees, whereby the adjusting directions of the adjust screws 8a and 8b are arranged to be almost perpendicular to each other and the adjust screws 8a and 8b can be adjusted substantially independently of each other. However, when the adjusting amounts of the adjust screws become large, the rod holder 5 not only is translated but also is rotationally moved with the leading ends of the respective adjust screws as the fulcrum thereof, which makes it difficult to adjust the adjust screws independently in the two directions perpendicular to each other. On the other hand, according to the present embodiment, the rod holder 5 has a shape including four side surfaces the mutually opposed surfaces of which are parallel to each other, and, on the respective side surfaces of the rod holder 5, there are disposed surface butting members 12. In the following description, the parts of the present embodiment which are the same in structure as those of the embodiment 1 are given the same reference numerals and thus the description thereof is omitted here. And, description will be given below only of the parts of the present embodiment which are different from those of the embodiment 1.

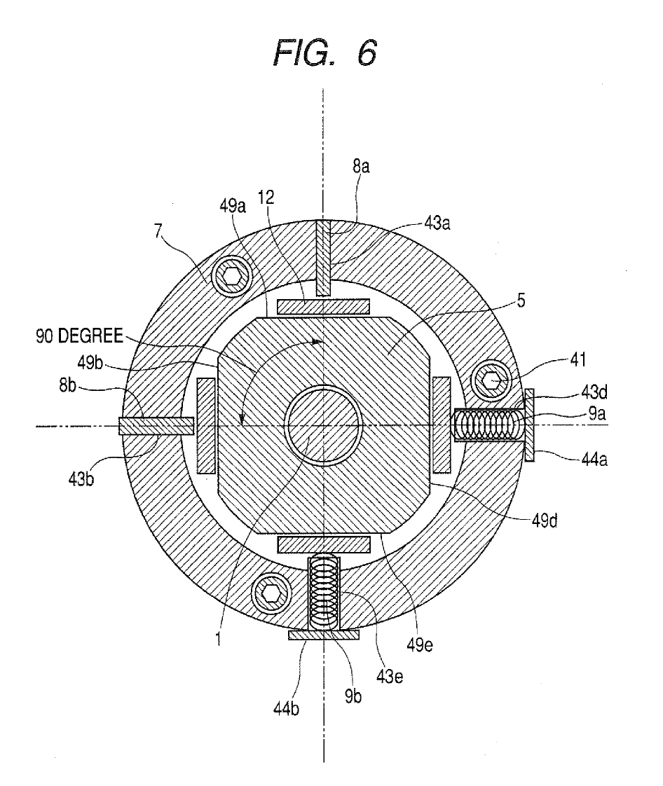

Now, FIG. 6 shows a rod-type solid laser apparatus according to an embodiment 6 of the invention and, specifically, it is a section view of one laser rod hold portion formed in one end portion of a cavity container. The other laser rod hold portion is also the same in structure as the rod hold portion shown in FIG. 6 and is arranged symmetrically to that shown in FIG. 6. More specifically, FIG. 6 is a transverse section view taken along the same direction of FIG. 1(b) relating to the embodiment 1.

In FIG. 6, in the adjust ring 7, similarly to the embodiment 1, there are formed first and second penetration holes 43a and 43b which respectively extend from the side surface of the adjust ring 7 to the recessed portion 40; and, instead of the penetration hole 43c, there are formed third and fourth penetration holes 43d and 43e respectively at positions which are opposed to the positions of the second and first penetration holes 43b and 43a. Thus, these four penetration holes, as shown in FIG. 6, are arranged in such a manner that the angles between the mutually adjoining penetration holes are respectively set 90 degrees. Into the first and second penetration holes 43a and 43b, similarly to the embodiment 1, there are screwed adjust screws 8a and 8b respectively; into the third and fourth penetration holes 43d and 43e, there are inserted springs 9a and 9b respectively; and, on the opening portions of the third and fourth penetration holes 43d and 43e existing on the side surface of the adjust ring 7, there are disposed covers 44a and 44b respectively. Due to this structure, the rod holder 5 is positioned in such a manner that it is supported at and can be pressed from four points composed of the two adjust screws 8a, 8b and two springs 9a, 9b. The four side surface portions of the rod holder 5, with which the adjust screws 8a, 8b and springs 9a, 9b are contacted respectively, include four planes 49a, 49b, 49d and 49e respectively extending perpendicularly to their associated adjust screws and springs. Since the four penetration holes 43a, 43b, 43d and 43e, into which their associated adjust screws 8 and springs 9 are inserted, are arranged in such a manner that the angles between the mutually adjoining penetration holes are 90 degrees respectively, the four planes 49a, 49b, 49d and 49e are also arranged in such a manner that the angles between the mutually adjoining planes are 90 degrees. For example, as shown in FIG. 6, the planes 49a and 49e are parallel to each other, the planes 49b and 49d are also parallel to each other, and the planes 49a, 49e are perpendicular to the planes 49b, 49d respectively. On the respective planes 49, there are disposed surface butting members 12, while materials for the surface butting members 12 may be selected from metal or nonmetal which can reduce the above-mentioned frictional resistance.

According to this structure, for example, in FIG. 6, when the screwing amount of the adjust screw 8a is adjusted, the position of the rod holder 5 in the right and left direction thereof is held by the adjust screw 8b and spring 9a, the planes 49b, 49d on which the adjust screw 8b and spring 9a are contacted with the rod holder 5 are respectively parallel to the screwing direction of the adjust screw 8a, and, on the surfaces of these planes, there are disposed their associated surface butting members 12 which are small in the frictional resistance. Therefore, the adjust screw 8b and spring 9a and the rod holder 5 are allowed to slide smoothly with respect to each other, and the spring 9b is expanded and compressed, whereby the position of the rod holder 5 can be adjusted only in the vertical direction. When the screwing amount of the adjust screw 8b is adjusted, similarly to the above operation, the spring 9a is expanded and compressed, thereby being able to adjust the position of the rod holder 5 only in the right and left direction thereof. This effect can hardly vary even when the adjusting amount becomes relatively large.

According to the present embodiment, the side surface of the rod holder 5 is formed to have a shape including four planes the mutually opposed ones of which are parallel to each other, on the four planes of the rod holder 5, there are disposed their associated surface butting members 12 respectively, and the pressures to be applied by the springs are set in the two directions, whereby not only there can be obtained a similar effect to the embodiment 1 but also, even in the range where the adjusting amount of the laser rod 1 is relatively large, the adjusting direction thereof is limited to directions which are perpendicular to each other to thereby be able to facilitate the adjustment of the laser rod 1.

### Embodiment 7

In the embodiment 6, the rod holder is pressed using the springs 9a and 9b, whereas, according to the present embodiment, instead of the springs 9, there are used plate springs 13. In the following description, the parts of the present embodiment which are the same in structure as those of the embodiment 1 are given the same reference numerals and thus the description thereof is omitted. That is, description will be given below only of the parts of the present embodiment which are different from those of the embodiment 1.

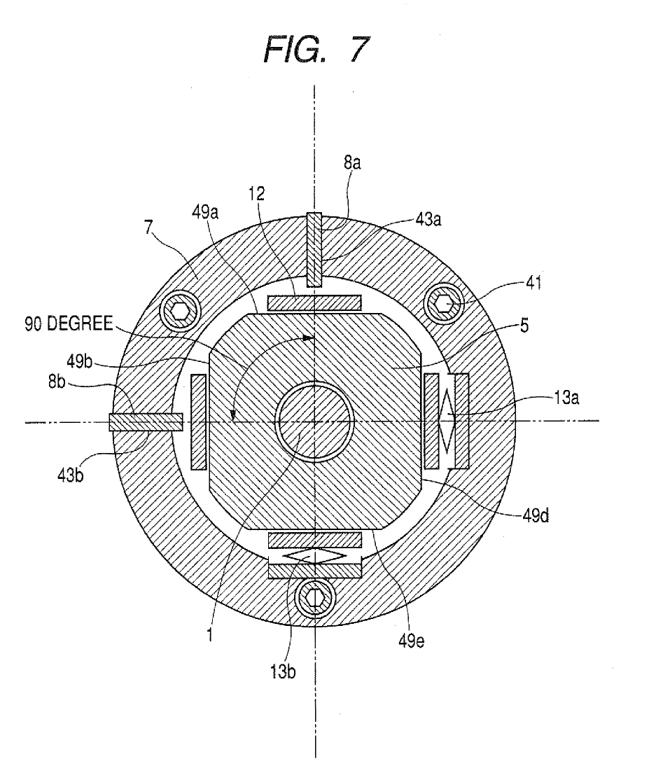

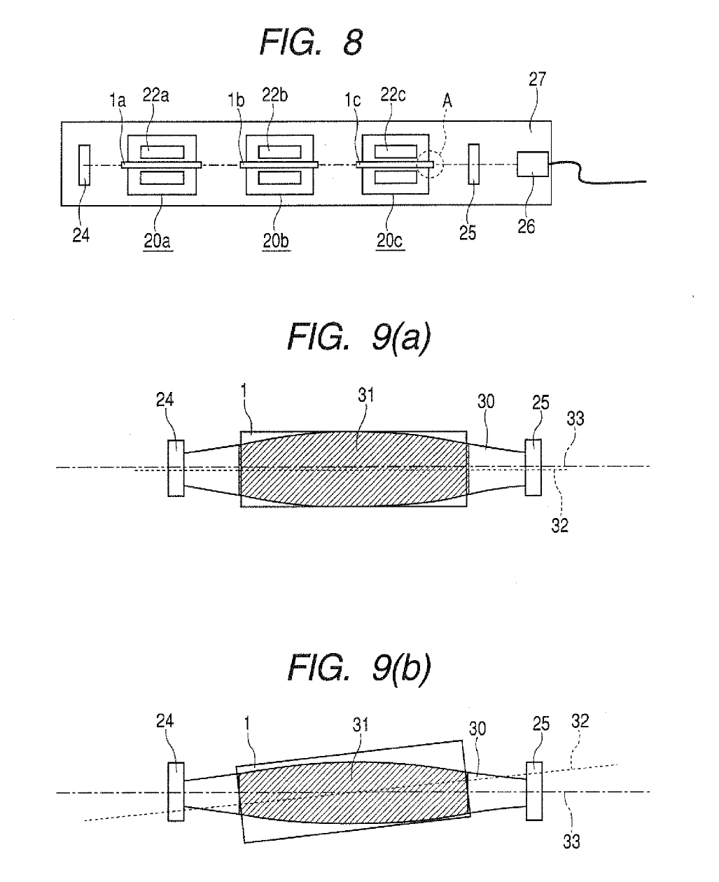

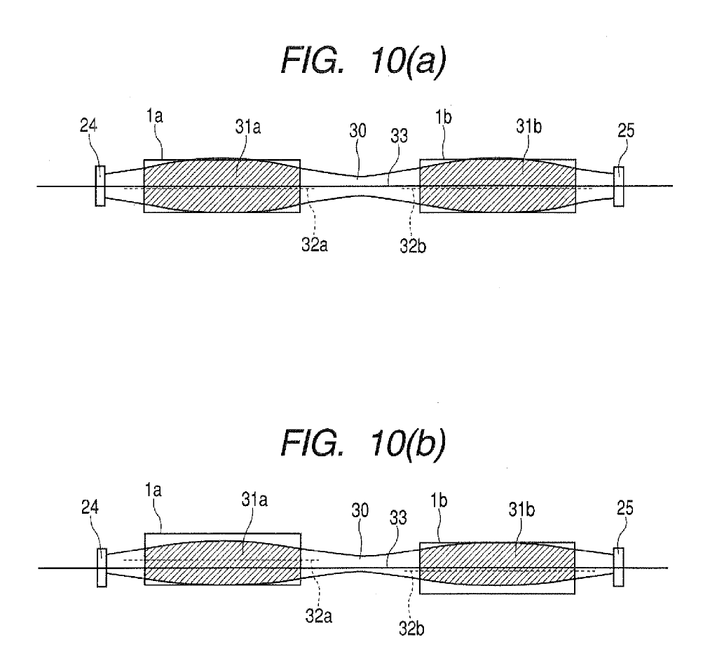

Now, FIG. 7 shows a rod-type solid laser apparatus according to an embodiment 7 of the invention and, specifically, it is a section view of one laser rod hold portion formed in one end portion of a cavity container. The other laser rod hold portion is also the same in structure to the laser rod hold portion shown in FIG. 7 and is arranged symmetrically to that shown in FIG. 7. More specifically, FIG. 7 is a transverse section view taken along the same direction as in FIG. 1(b) which relates to the embodiment 1.

As shown in FIG. 7, because there are used the plate springs 13a and 13b instead of the springs 9a and 9b employed in the embodiment 6, there is eliminated the need for provision of the penetration holes 43d, 43e and the covers 44a, 44b. Therefore, when compared with the embodiment 6, the structure of the adjust ring 7 can be simplified and the outer shape thereof can be reduced in size. It goes without saying that the present embodiment can provide such effects as equivalent to the embodiment 6.

### INDUSTRIAL APPLICABILITY

As has been described heretofore, a laser apparatus according to the invention can be used effectively as a laser apparatus including two or more cavities arranged in a mutually adjoining manner, and a laser apparatus in which one or more of cavities are replaced in the maintenance thereof.

1. A rod-type solid laser apparatus comprising:
a rod-type solid laser medium;
an excitation light source that radiates an excitation light onto the solid laser medium from the lateral side thereof to excite the solid laser medium;
two support plates respectively disposed on both end portions of the solid laser medium and each having an opening in the vicinity of an axis of the solid laser medium;
a rod holder that holds at least one end portion of the solid laser medium;
at least two adjusting units that respectively adjust a position of the rod holder in a direction substantially perpendicular to the rod-type solid laser medium;
at least one elastic member that presses the rod holder in a direction substantially perpendicular to the rod-type solid laser medium;
a holding unit that is fixed to the outside of the support plates so as to be disposed in the periphery of the rod holder and holds the adjusting units and the elastic member; and
a seal unit interposed between the rod holder and the support plates.

2. (canceled)

3. The rod-type solid laser apparatus as set forth in claim 1, further comprising:
a first hole formed in the rod holder so as to penetrate through the rod holder;
a second hole formed in the support plate coaxially with the first hole and having a screw thread formed on the inner surface thereof; and
a screw including a terminal end portion having a diameter larger than a diameter of the first hole,
wherein the screw presses the rod holder to the support plate.

4. The rod-type solid laser apparatus as set forth in claim 1,
wherein the holding unit includes an adjust ring,
wherein the adjust ring is fixed to the support plates and includes a recessed portion that holds the rod holder therein,
wherein the bottom surface of the recessed portion is in contact with the rod holder,
wherein the bottom surface of the recessed portion is capable of pressing the rod holder to the support plate, and
wherein the recessed portion has a diameter larger than the diameter of the rod holder.

5. The rod-type solid laser apparatus as set forth in claim 4, wherein the adjusting unit includes:
a hole opened up in the recessed portion of the adjust ring and having a screw thread formed on the inner surface thereof; and
a screw screwed into the hole.

6. The rod-type solid laser apparatus as set forth in claim 5, wherein the hole penetrates from the side surface of the adjust ring to the recessed portion and extends in a direction perpendicular to the rod-type solid laser medium.

7. The rod-type solid laser apparatus as set forth in claim 5,
wherein the hole penetrates from the bottom surface of the adjust ring to the recessed portion and extends in a direction parallel to the rod-type solid laser medium, and
wherein the rod holder includes an inclined surface at a portion where the screw screwed into the hole is contacted with.

8. The rod-type solid laser apparatus as set forth in claim 6, further comprising a bush disposed on a portion of the side surface of the rod holder, at which the pressing unit and the elastic member are contacted with each other.

9. The rod-type solid laser apparatus as set forth in claim 8, further comprising an adjust roller disposed on the adjust ring so as to be in contact with the rod holder and rotate the rod holder about a center axis of the rod-type solid laser medium.

10. The rod-type solid laser apparatus as set forth in claim 6,
wherein the number of the adjusting unit is two, and the two adjusting units are arranged such that an angle formed between the two adjusting units is set 90 degrees,
wherein the number of the elastic members is two, and the two elastic members are arranged symmetric to the positions of the two adjusting units with respect to a center axis of the rod-type solid laser medium, and
wherein the side surface portions of the rod holder at which the adjusting units and the elastic members are contacted with the rod holder are respectively formed as planes that extend perpendicularly to the adjusting units and the elastic members.

11. The rod-type solid laser apparatus as set forth in claim 4, wherein the elastic member includes a spring inserted into a hole opened up in the recessed portion of the adjust ring.

12. The rod-type solid laser apparatus as set forth in claim 4, wherein the elastic member includes a plate spring disposed on the side surface of the recessed portion of the adjust ring.

13. The rod-type solid laser apparatus as set forth in claim 1, further comprising a fixing unit that fixes the rod holder.

14. The rod-type solid laser apparatus as set forth in claim 13, wherein the fixing unit includes:
a first hole formed in the rod holder so as to penetrate through the rod holder;
a second hole formed in the support plate coaxially with the first hole and having a screw thread formed on the inner surface thereof; and
a screw screwed through the first hole into the second hole, the terminal end portion of the screw having a diameter larger than the diameter of the first hole.
